(19) United States
(12) Patent Application Publication
(10) Pub. No.: US 2017/0214715 A1
(43) Pub. Date: Jul. 27, 2017

(54) VIOLATION INFORMATION INTELLIGENCE ANALYSIS SYSTEM

(71) Applicant: KOREA INTERNET & SECURITY AGENCY, Seoul (KR)

(72) Inventors: Seul Gi LEE, Seoul (KR); Hyei Sun CHO, Seoul (KR); Nak Hyun KIM, Seoul (KR); Byung Ik KIM, Seoul (KR); Tai Jin LEE, Seoul (KR)

(21) Appl. No.: 15/006,761

(22) Filed: Jan. 26, 2016

(30) Foreign Application Priority Data
Jan. 26, 2016 (KR) 10-2016-0009133

(51) Int. Cl. H04L 29/06; G06F 17/30

(52) U.S. Cl. CPC H04L 63/20; H04L 63/1433; H04L 63/1416; H04L 63/145; G06F 17/30424; H04L 63/1425; G06F 17/30569

(57) ABSTRACT

Provided is a violation information intelligence analysis system configuring an AEGIS along with a violation incident association information collection system, including a violation information management module configured to manage information and violation information intelligence analysis-related information received from the violation incident association information collection system, a collection information analysis module configured to extract a violation information ID based on the received information and to extract a relationship between the violation information ID and raw data, an intelligence generation and management module configured to generate intelligence based on a policy stored in the violation information intelligence analysis system in response to an intelligence generation request, convert a format of the intelligence in order to externally transfer the intelligence, and store history information, and an intelligence analysis module configured to support an in-depth information (N-depth) analysis and a relationship analysis using information extracted from a violation information DB.

### CROSS REFERENCE TO RELATED APPLICATION

The present application claims the benefit of Korean Patent Application No. 10-2016-0009133 filed in the Korean Intellectual Property Office on Jan. 26, 2016, the entire contents of which are incorporated herein by reference.

### BACKGROUND OF THE INVENTION

1. Technical Field

Embodiments relate to the integrated security situation analysis system of a cyber black box technology and, more particularly, to the accumulated and integrated intelligence system (AEGIS) of an integrated security situation analysis system.

2. Description of the Related Art

During the past 10 years, malware based on a PC continues to be increased. A total of 1.9 hundred million malware was counted to be distributed in 2013. Furthermore, since the subject of cyber violations are aimed at specific businesses, institutions, and major facilities, the volume of damage thereof tends to be global in addition to local.

There is active research carried out on the development of countermeasure technologies, but there is a limit to a proper measure, such as that several months were taken to analyze the cause of the attack of the 3.20 cyber terror. In order to overcome such a limit, first, there is a need for a cause analysis and attack reproduction technology for a violation incident. Second, there is a need for a rapid sharing and countermeasure system for violation incident-related information. Third, there is a need for a security intelligence service.

A variety of types of research and technology development regarding a cyber black box technology capable of satisfying the three needs are in progress.

FIG. 1 is a conceptual diagram showing a cyber black box technology.

As shown in FIG. 1, the cyber black box technology basically includes a cyber black box and an integrated security situation analysis system.

The cyber black box is a system for the preservation of evidence, a rapid analysis of a cause, and the tracking of an attacker for an advanced violation attack, and can collect and analyze high-capacity network traffic information of 10 G in real time. The cyber black box can early detect and handle a violation attack through a rapid analysis.

The integrated security situation analysis system performs a cloud-based large-scale malware analysis, mobile violation incident analysis and handling, violation incident profiling and attack prediction, and violation incident information sharing.

The integrated security situation analysis system performs classification and processing according to PCs and mobiles by taking into consideration a threat environment for each platform and can perform the tracking of an attacker and the prediction of an attack through association analysis and profiling based on a variety of types of violation incident information other than a previous simple detection/analysis level.

The integrated security situation analysis system integrates and implements various systems in order to perform an intelligent information analysis based on information collected by a plurality of cyber black boxes.

The integrated security situation analysis system needs to be equipped with an accumulated and integrated intelligence system (AEGIS) for calculating base data for the subject of analysis of a cyber black box and deriving related (or similar) violation information through an intelligence analysis.

### SUMMARY OF THE INVENTION

The integrated security situation analysis system of the cyber black box technology needs to be equipped with an accumulated and integrated intelligence system (AEGIS) in order to calculate base data for the subject of analysis of a cyber black box and to derive related (or similar) violation information which cannot be checked using only one violation incident analysis through an intelligence analysis, but a detailed configuration and design scheme of the AEGIS have not been prepared.

Furthermore, there is a need for research and the development of a technology regarding a detailed configuration and operating method of systems (e.g., a collection system and an analysis system) by designing the AEGIS so that it includes the collection system and the analysis system.

Accordingly, the present invention has been made keeping in mind the above problems occurring in the prior art, and an object of the present invention is to provide a violation information intelligence analysis system for configuring the AEGIS of an integrated security situation analysis system.

Additional characteristics and advantages of the present invention will be described in the following description and will be partially made evident by the description or understood by the execution of the present invention. The object and other advantages of the present invention will be implemented by, in particular, structures written in the claims in addition to the following description and the accompanying drawings.

### BRIEF DESCRIPTION OF THE DRAWINGS

FIG. 1 is a conceptual diagram showing a cyber black box technology.

FIG. 2A is a block diagram showing the configuration of an AEGIS according to an embodiment of the present invention.

FIG. 2B is a block diagram showing the configuration of a violation information intelligence analysis system according to an embodiment of the present invention.

FIG. 3 is a block diagram showing the configuration of a violation information management module according to an embodiment of the present invention.

FIG. 4 is a sequence diagram showing a violation incident association information collection unit according to an embodiment of the present invention.

FIG. 5 is a block diagram showing the configuration of a collection information analysis module according to an embodiment of the present invention.

FIG. 6 is a block diagram showing the configuration of an intelligence generation and management module according to an embodiment of the present invention.

FIG. 7 is a block diagram showing the configuration of an intelligence analysis module according to an embodiment of the present invention.

FIG. 8 is a diagram illustrating a data configuration according to an N-depth analysis.

FIG. 9 is a block diagram showing the configuration of a violation information DB according to an embodiment of the present invention.

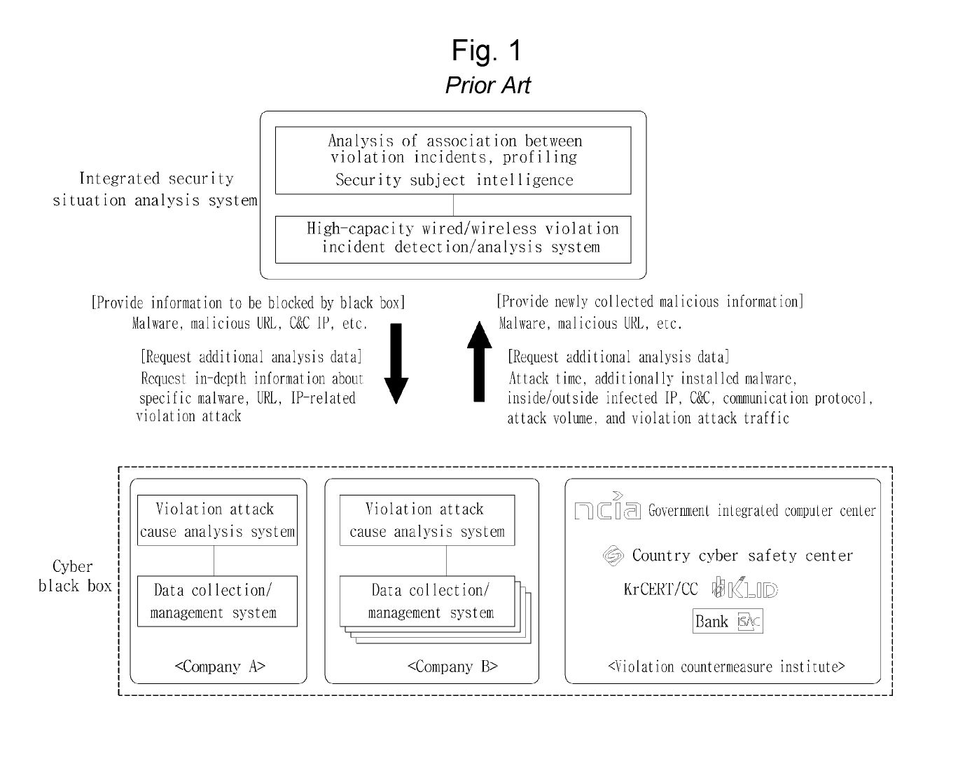

### DETAILED DESCRIPTION

In accordance with an embodiment of the present invention, a violation information intelligence analysis system configures an accumulated and integrated intelligence system (AEGIS) along with a violation incident association information collection system and includes a violation information management module configured to manage information and violation information intelligence analysis-related information received from the violation incident association information collection system, a collection information analysis module configured to extract a violation information ID based on the received information and to extract a relationship between the violation information ID and raw data, an intelligence generation and management module configured to generate intelligence based on a policy stored in the violation information intelligence analysis system in response to an intelligence generation request, convert a format of the intelligence in order to externally transfer the intelligence, and store history information, and an intelligence analysis module configured to support an in-depth information (N-depth) analysis and a relationship analysis using information extracted from a violation information DB.

The violation information management module is configured to include a violation incident association information collection unit configured to analyze the information received from the violation incident association information collection system and log the analyzed information, a violation information ID management unit configured to query the violation information DB about an ID of violation information and issue an ID to violation information to which a query result ID has not been assigned, and a violation information management unit configured to query the violation information DB about the raw data or relationship information or store the raw data or the relationship information in the violation information DB and to query the violation information DB about information derived based on an analysis base defined by the violation information intelligence analysis system or an administrator.

The collection information analysis module is configured to include an RA extraction unit configured to extract information which include a violation resource or attributes and which is managed as a violation information ID from information received from the violation incident association information collection system, obtain a violation information ID from the violation information ID management unit, and replace the extracted information with the obtained violation information ID, a raw data management unit configured to analyze violation information processed using a violation information ID extraction function and to convert the analyzed violation information into a form managed in the violation information DB, and a relationship management unit configured to analyze a relationship between the violation resources and a relationship between the violation resource and the attribute information based on raw data received from the violation incident association information collection system and to convert the analyzed relationships into a form managed in the violation information DB.

The intelligence generation and management module is configured to include a intelligence format conversion unit configured to fetch a black box information access controller and to convert intelligence analysis results into a format for an operation in conjunction with a black box, an intelligence generation unit configured to generate intelligence based on results analyzed by executing the intelligence analysis module, and an intelligence history management unit configured to perform a query on an analysis request for the intelligence and analysis results of the intelligence and store the analysis request for the intelligence and the analysis results of the intelligence.

The intelligence analysis module is configured to include an analysis information extraction unit configured to perform a query on base information for an intelligence analysis and request a collection of additional information, an N-depth analysis unit configured to construct an N-depth relationship corresponding to a depth setting value using an analysis information extraction function, map the constructed N-depth relationship to the violation information, and convert results of the mapping into data of an intelligence format, and a relationship analysis unit configured to select subjects of comparison of violation resources for a relationship analysis and perform a comparison and query on pieces of identically or similarly used information between the selected subjects of comparison.

Hereinafter, embodiments of the present invention are described in detail with reference to the accompanying drawings in order for those skilled in the art to which the present invention pertains to be able to easily practice the present invention. The same or similar reference numerals are used to denote the same or similar elements throughout the drawings.

In accordance with an embodiment of the present invention, a violation information intelligence analysis system for a cyber black box and an integrated cyber security situation analysis technology for the preliminary and posterior handling of a cyber attack has been implemented. The violation information intelligence analysis system according to an embodiment of the present invention constructs an integrated information configuration and a violation incident model based on information collected by the violation incident association information collection system with respect to a cyber violation incident and performs an intelligence analysis function.

Prior to a description of the present invention, various terms used in the description of the violation information intelligence analysis system, that is, a violation incident, violation incident information, a violation resource, attributes, an analysis base, association information, intelligence, an intelligence analysis, and a violation incident model are defined below.

The violation incident means a case where a malicious behavior has been performed on assets forming an information processing system.

The violation incident information means information which has been analyzed and structurally configured in relation to a violation incident through a single piece of violation information or a plurality of pieces of violation information or through a combination of extracted violation resources and pieces of associated information.

The violation resource is major information (e.g., an IP, a domain, and a malware) forming a violation incident.

The attributes are values calculated when violation resources are collected, queried, and analyzed and are information not belonging to the category of a violation resource.

The analysis base is a base, that is, the meaning of intelligence analysis results.

The association information is information including a mutual relationship between violation resources.

The intelligence is indicative of the results of the detection of additional information through an analysis of collected information, such as notification and log information provided by a normal integrated security control solution.

The intelligence analysis is indicative of an analysis method for generating intelligence.

The violation incident model is a model constructed based on a pattern derived the analysis results of a violation information group target.

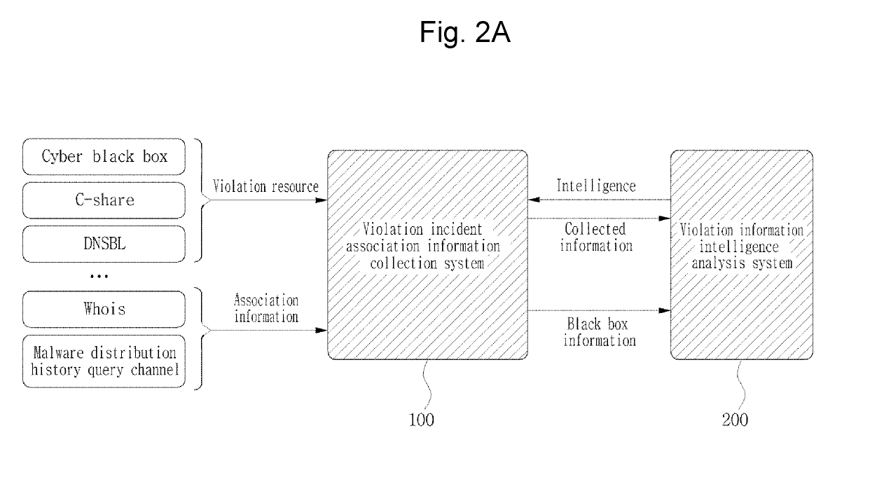

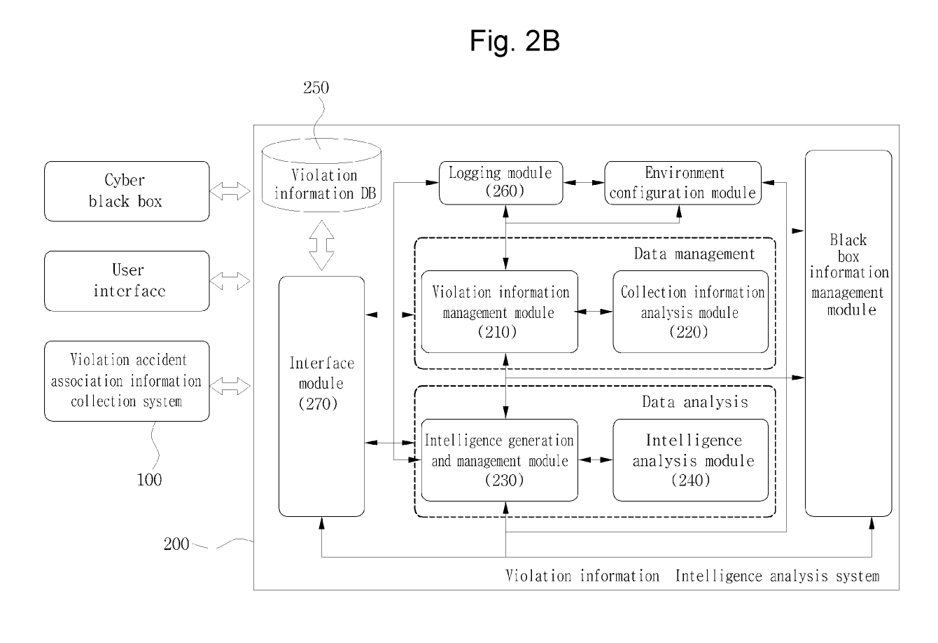

FIG. 2A is a block diagram showing the configuration of an accumulated and integrated intelligence system (AEGIS) according to an embodiment of the present invention.

As shown in FIG. 2A, the AEGIS includes a violation accident association information collection system 100 and a violation information intelligence analysis system 200.

The violation accident association information collection system 100 collects violation incident-related information (or violation resources) through an external violation incident information collection channel (e.g., a cyber black box, C-share, a DNSBL and/or a distribution place/malware sharing channel (5 sites in addition to virusshare.com)) including a cyber black box, queries an external resource query system about association information about the violation incident-related information, and collects and manages a variety of types of analysis information about a single violation resource.

The violation information intelligence analysis system 200 collects cyber violation incident information, collected by the violation incident association information collection system 100, periodically or aperiodically and generates intelligence information. Accordingly, the violation information intelligence analysis system 200 tends to be dependent on the violation incident association information collection system 100. In order to solve such a problem, there is provided an environment in which storage and management are performed in accordance with a database storage format adopted by the violation incident association information collection system 100 and an intelligence analysis is independently performed although there is no information collected by the violation incident association information collection system 100.

Furthermore, it is efficient to store information in the violation information intelligence analysis system 200 based on a cache concept in order to improve intelligence analysis performance because resources for an intelligence analysis are enormous and reference needs to be made to collected information in various ways. Intelligence calculated by the violation information intelligence analysis system 200 is transmitted through an API service and file. In a portion associated with a cyber black box, black box information transmitted by the violation incident association information collection system 100 is stored for each device, and an analysis seed request and the history of the results are managed.

FIG. 2B is a block diagram showing the configuration of the violation information intelligence analysis system according to an embodiment of the present invention.

As shown in FIG. 2B, the violation information intelligence analysis system 200 according to an embodiment of the present invention is configured to include a violation information management module 210, a collection information analysis module 220, an intelligence generation and management module 230, an intelligence analysis module 240, a violation information database (DB) 250, a logging module 260, and an interface module 270.

The violation information management module 210 is a module for managing information and violation information intelligence analysis-related information received from the violation incident association information collection system 100. The violation information management module 210 accesses data for violation information and provides raw data and relationship information.

The violation information management module 210 functions as a main unit for analyzing information received from the violation incident association information collection system 100 and manages violation information IDs. Furthermore, the violation information management module 210 performs a violation information management function for accessing the violation information DB 250, querying the violation information DB as to data, and storing the data. The violation information includes violation resource information and attribute information.

The collection information analysis module 220 is a module for extracting a violation information ID from data received from the violation incident association information collection system 100 and extracting raw data and a relationship from the data. The collection information analysis module 220 receives and analyzes collected information and does not communicate with modules other than the violation information management module 210.

The intelligence generation and management module 230 generates intelligence based on a policy stored in the violation information intelligence analysis system 200 in response to an intelligence generation request and performs the conversion of an intelligence format and the storage of history information for external transfer purposes. The intelligence generation and management module 230 is responsible for the generation of intelligence.

The intelligence analysis module 240 actually performs an intelligence analysis based on information stored in the violation information DB 250. The intelligence analysis module 240 is a module for supporting the extraction of information that is used in common, an in-depth information analysis (N-depth analysis) using the information, and a relationship analysis. The intelligence analysis module 240 does not communicate with modules other than the intelligence generation and management module 230.

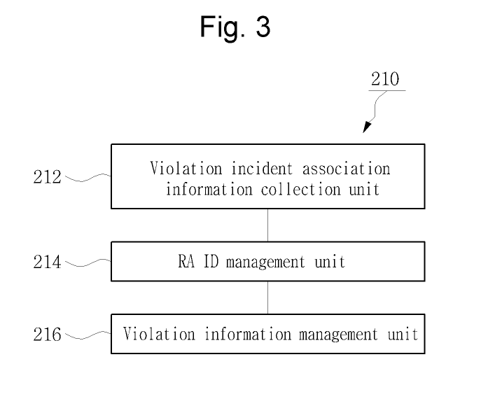

FIG. 3 is a block diagram showing the configuration of the violation information management module 210 according to an embodiment of the present invention.

As shown in FIG. 3, the violation information management module 210 according to an embodiment of the present invention is configured to include a violation incident association information collection unit 212, an RA ID management unit 214, and a violation information management unit 216. The violation information management module 210 manages information and violation information intelligence analysis-related information received from the violation incident association information collection system 100.

The violation incident association information collection unit 212 analyzes information received from the violation incident association information collection system 100 and logs the analyzed information.

The violation incident association information collection unit 212 performs an analysis of violation incident association information, the collection and logging of violation information, and an analysis of a CBS priority request XML format.

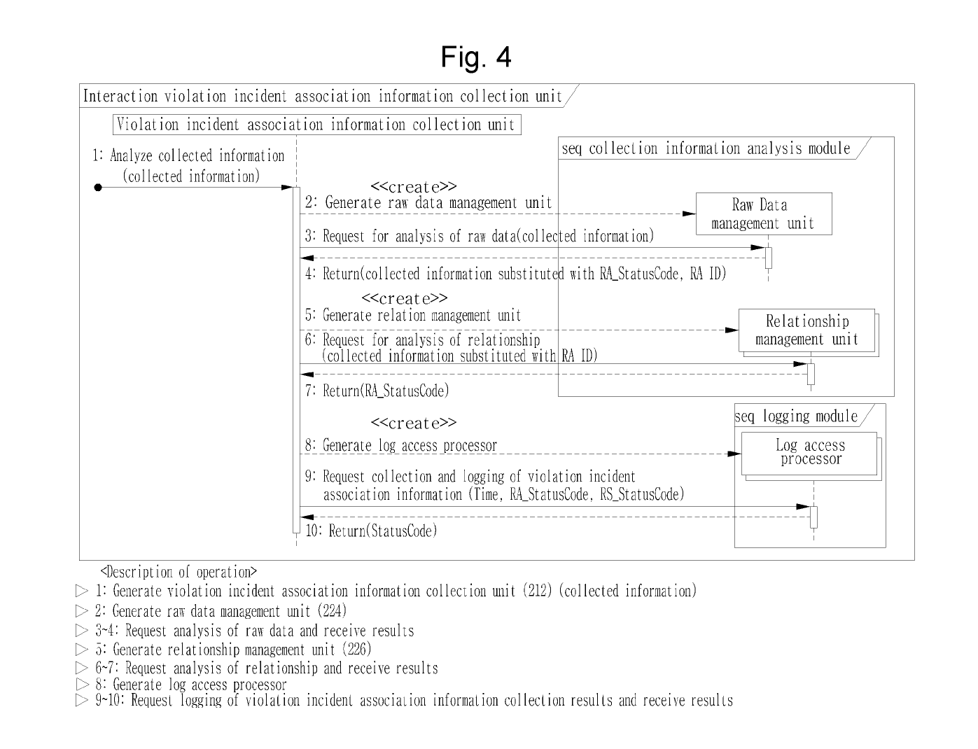

In the case of the violation incident association information analysis, first, a violation incident association information access processor (i.e., the interface module 270) generates the violation incident association information collection unit 212, and the generated violation incident association information collection unit 212 receives information from the violation incident association information collection system 100, as shown in FIG. 4. Furthermore, the generated violation incident association information collection unit 212 executes the raw data management unit 224 of the collection information analysis module 220.

In response to the execution, the raw data management unit 224 executes the RA extraction unit 222 and issues an ID for the violation resources and the attributes of raw data. Furthermore, the raw data management unit 224 stores the issued ID instead of the violation resources and attributes.

Furthermore, the violation incident association information collection unit 212 fetches a relationship management unit 226. In this case, the raw data address, that is, a parameter of the raw data management unit 224, is transmitted as a parameter.

The collection and logging of violation information is a procedure for requesting a history, related to a process stored in the violation information DB 250, from the logging module 260 after an analysis of violation incident association information is completed.

If the collection of violation information is to be logged, the violation incident association information collection unit 212 receives return values from the raw data management unit 224 and the relationship management unit 226 after an analysis of collected information is completed.

The violation incident association information collection unit 212 requests the collection and logging of violation information from the logging module 260 based on time when the violation information management module 210 is generated (e.g., the time when information collected through the interface module 270 is received and when an analysis request is made), as shown in FIG. 4. The format of the collection and logging of violation information is defined in the logging module 260. FIG. 4 is a sequence diagram showing the violation incident association information collection unit according to an embodiment of the present invention and illustrates a violation incident association information analysis request procedure and a violation information collection and logging procedure.

In the case of the analysis of a CBS priority request XML format, if information requested by a cyber black box has not been stored, the violation incident association information collection system 100 collects the requested information. Furthermore, the violation incident association information collection system 100 sends the collected information and a message that requests the violation information intelligence analysis system 200 to analyze information collected in the XML format to the violation information intelligence analysis system 200.

Accordingly, the transmitted message and the collected information are transferred to the interface module 270 (i.e., a violation incident association information access processor) of the violation information intelligence analysis system 200. The violation incident association information collection unit 212 analyzes the received information analysis request message and collected information and converts the analysis request message and collected information into raw data.

The RA ID management unit 214 queries the violation information DB 250 about the ID of violation information (including violation resource information and attribute information) (hereinafter referred to as an “RA ID”) and issues an ID to violation information to which an ID has been assigned as a result of query.

When an RA ID query request message is received, the RA ID management unit 214 generates a violation information DB access processor and queries the violation information DB 250 about an ID assigned to a violation resource and attributes through the violation information DB access processor with reference to the input value of the RA ID query request message.

The input value of the RA ID query request message includes operation mode information, a violation resource/attribute value, and a violation resource (R)/attribute (A) type. In this case, the violation resource (R)/attribute (A) type information is optional. Operation mode is set as a simple query and a generation query. If operation mode is set as the generation query, the RA ID management unit 214 issues a new violation resource/attribute ID (hereinafter referred to as an “RA ID”) if a corresponding violation resource ID (hereinafter referred to as an “RID”) or attribute ID (hereinafter referred to as an “AID”) is not present and returns the RA ID.

The violation information management unit 216 queries the violation information DB 250 about raw data or relationship information or stores raw data or relationship information in the violation information DB 250. The violation information management unit 216 queries the violation information DB 250 about information derived by an analysis base defined by a system or administrator. The violation information management unit 216 has a query request of 5 bits and a violation information value as an input value.

The violation information management unit 216 performs a query regarding the raw data (or raw data region) or relationship information (or a relationship region) of the violation information value through the violation information DB access processor with reference to the input value (e.g., the query request of 5 bits and the violation information value) and returns the results of the query.

The violation information management unit 216 performs a raw data query, a relationship From query between violation resources, a relationship To query between violation resources, a relationship query between violation resources and attributes, and a relationship query between attributes and violation resources based on the query request information of the input value.

The input value includes query request information of 5 bits and a violation information value as shown in Table 1.

TABLE 1

| Query request of 5 bits | | | | | |
|---|---|---|---|---|---|
| RID(1)/ | Raw | RR- | RR- | | |
| AID (0) | data | From | To | RA | Description |
| 1 | | | | 1 | RA-Relationship |
| | | | 1 | | RID = To of RR-Relationship |
| | | 1 | | | RID = From of RR-Relationship |
| | 1 | | | | RawData |
| 0 | 0 | 0 | 0 | 0 | Return of violation resource |
| | | | | | ID/value associated with |
| | | | | | attributes |

The violation information management unit 216 returns a data block in response to a query request based on a combination of bits in Table 1. However, the violation information management unit 216 is unable to process a combination of query requests classified into an RID and an AID.

In the case of a raw data query, first, the violation information management unit 216 fetches the violation information DB access processor of the interface module 270, performs a query on raw data (or a raw data region), and returns a queried result value.

The violation information management unit 216 obtains the ID of a violation resource by inputting the value of the violation resource to the RA ID management unit 214.

Furthermore, the violation information management unit 216 checks a raw data table and a seq location by querying a mapping table based on the type of obtained ID.

Thereafter, the violation information management unit 216 repeats and accumulates data by the number of tables in which violation resources are placed and returns the accumulated data.

In the case of the relationship From query between violation resources, the violation information management unit 216 obtains the ID of a violation resource by inputting the value of the violation resource to the RA ID management unit 214. Thereafter, the violation information management unit 216 queries a tb_resource_relationship table about data based on the obtained ID and returns the queried data. The violation information management unit 216 queries a From column about only data including the violation resource.

In the case of the relationship To query between violation resources, the violation information management unit 216 obtains the ID of a violation resource by inputting the value of the violation resource to the RA ID management unit 214. Thereafter, the violation information management unit 216 queries the tb_resource_relationship table based on the obtained ID and returns the queried data. The violation information management unit 216 queries a To column about only data including the violation resource.

In the case of the relationship query between violation resources and attributes, the violation information management unit 216 obtains the ID of a violation resource by inputting the value of the violation resource to the RA ID management unit 214. Thereafter, the violation information management unit 216 queries the tb_attribute_relationship table about data based on the obtained ID and returns the queried data.

In the case of the relationship query between attributes and violation resources, the violation information management unit 216 obtains the ID of an attribute by inputting the value of a violation resource to the RA ID management unit 214. Thereafter, the violation information management unit 216 queries the tb_attribute_relationship table about data based on the obtained ID and returns the queried data.

Furthermore, the violation information management unit 216 according to an embodiment of the present invention stores violation information intelligence analysis results.

The violation information management unit 216 receives intelligence analysis results from the intelligence generation unit 234 of the intelligence generation and management module 230 and stores the intelligence analysis results through a violation information DB access processor. The violation information management unit 216 manages intelligence analysis results under the definition that the intelligence analysis results include violation information.

Furthermore, the violation information management unit 216 according to an embodiment of the present invention may request the additional collection of violation information.

The violation information management unit 216 basically functions to perform a query about data for performing a violation information intelligence analysis. If detected data is not present, the violation information management unit 216 may request the violation incident association information collection system 100 to collect additional information through an API tool.

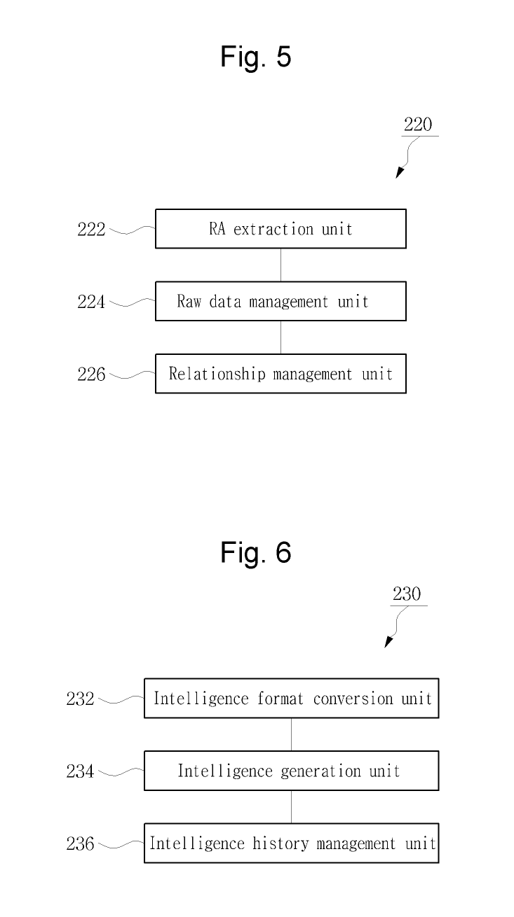

FIG. 5 is a block diagram showing the configuration of the collection information analysis module 220 according to an embodiment of the present invention.

As shown in FIG. 5, the collection information analysis module 220 according to an embodiment of the present invention is configured to include the RA extraction unit 222, the raw data management unit 224, and the relationship management unit 226. The collection information analysis module 220 extracts a violation information ID based on received information and extracts a relationship between the violation information ID and raw data.

The RA extraction unit 222 extracts information which may be managed as a violation information ID, such as a violation resource or attributes, from information received from the violation incident association information collection system 100, obtains a violation information ID from the violation information ID management unit 214, and substitutes the extracted information with the obtained violation information ID.

The RA extraction unit 222 extracts a column, corresponding to a violation resource and attributes, from violation incident association information raw data and performs a query about a violation resource ID and an attribute ID according to an input value or issues a violation resource ID and an attribute ID according to an input value. The input value includes operation mode information (e.g., the extraction of raw data and a value query), violation information (e.g., a violation resource/attribute value), and a violation resource (R)/attribute (A) type. In this case, the violation resource (R)/attribute (A) type information is optional. The violation resource (R)/attribute (A) type information is included in the input value when operation mode is designated as value query mode.

If operation mode is designated as raw data extraction mode, the RA extraction unit 222 checks major information and the type of major information which need to be extracted based on the attribute value of violation information included in the input value. Furthermore, the RA extraction unit 222 determines that which one of the IDs of a violation resource and attribute needs to be queried and issued based on the type of major information.

Thereafter, the RA extraction unit 222 checks whether the determined value (e.g., the violation resource value or attribute value) is present by querying the violation information DB 250 and returns the determined value if, as a result of the check, the determined value is found to be present.

In contrast, if, as a result of the check, the determined value is found to be present, the RA extraction unit 222 issues an ID by adding 1 to the most recently returned value and returns the issued ID as a result value. Furthermore, the RA extraction unit 222 stores the issued ID and the determined value (e.g., the violation resource value or attribute value) in tb_resource_id (or tb_attribute_id).

If operation mode has been designated as value query mode, the RA extraction unit 222 checks violation resource (R)/attribute (A) type information included in the input value and determines that which one of the IDs of a violation resource and attributes will be queried and issued based on a violation resource (R)/attribute (A) type.

Thereafter, the RA extraction unit 222 checks whether the determined value (e.g., the violation resource value or attribute value) is present by querying the violation information DB 250 and returns the determined value if, as a result of the check, the determined value is found to be present.

In contrast, if, as a result of the check, the determined value is found to be present, the RA extraction unit 222 issues an ID by adding 1 to the most recently returned value and returns the issued ID as a result value. Furthermore, the RA extraction unit 222 stores the issued ID and the determined value (e.g., the violation resource value or attribute value) in tb_resource_id (or tb_attribute_id).

In an embodiment of the present invention, there are ID issue criteria for violation resources and attributes.

ID issue criteria based on the definition of a violation resource include an IP, a domain, and hash. ID issue criteria based on the definition of attributes include e-mail, geographical information, similarity group information, and a file name (or path).

The RA extraction unit 222 does not issue an ID although the same type is present. Furthermore, the RA extraction unit 222 does not issue an ID for data determined to be not used in the future (e.g., a name server address in a Whois query table).

The extraction of major information is different for each table based on such ID issue criteria. The selection of major information is determined by a negotiation between common research institutions through a database specification or separate document.

The raw data management unit 224 according to an embodiment of the present invention analyzes violation information processed using a violation information ID extraction function and converts the violation information into a form managed in the violation information DB 250. The raw data management unit 224 fetches the RA extraction unit 222 and modifies and stores raw data.

The raw data management unit 224 fetches the RA extraction unit 222 in order to obtain the IDs of elements forming violation information, that is, a violation resource and attributes. Furthermore, the fetched RA extraction unit 222 extracts violation resource information or attribute information included in violation incident association information and obtains a violation resource ID or an attribute ID.

When the RA extraction unit 222 is fetched, operation mode of the RA extraction unit 222 is designated as raw data extraction mode.

After replacing the value of analysis base information with the obtained ID (or number), the raw data management unit 224 stores the obtained ID (or number) in the violation information DB 250 through a raw data storage procedure.

In order to perform a raw data storage function, first, the raw data management unit 224 fetches the violation information management unit 216 and stores the replaced value in the violation information DB 250. Furthermore, the result value (e.g., the replaced value) is returned to the violation incident association information collection unit 212 (or the violation information management unit 216) which has fetched the raw data management unit 224. The return of the result value is for logging that violation incident association information has been analyzed and stored.

The relationship management unit 226 analyzes (or extracts) a relationship between violation resources and a relationship between violation resource information and attribute information based on raw data received from the violation incident association information collection system 100 and converts the analyzed relationships into a form managed in the violation information DB 250. Furthermore, the relationship management unit 226 receives violation resource (e.g., an IP, a domain, and hash) information as an input value.

In order to extract a relationship, first, the relationship management unit 226 divides the relationship into large classification and small classification based on an input value (e.g., a violation resource (e.g., an IP, a domain, or hash).

Since relationship information is stored based on an RA ID, the relationship management unit 226 fetches the RA ID management unit 214 of the violation information management module 210 and obtains a violation resource ID (or attribute ID).

As shown in Table 2 to Table 4, the relationship management unit 226 configures a relationship class based on the specification of tb_resource_relationship and tb_attribute_relationship stored and managed in the violation information DB 250. The relationship management unit 226 does not perform a separate format conversion procedure because the configured relationship class is the same as the storage format of the violation information DB 250.

Table 2 is a mapping table for analysis base if an input value is an IP.

TABLE 2

| | | | Mapped DB table and | | |
|---|---|---|---|---|---|
| | Analysis base | | column {table name}. | | |
| | Large | Small | {column name} | | |
| Input | classifi- | classifi- | (column for obtaining | | |
| type | cation | cation | IP) | Description | Use |
| IP | IP | IP band | No | IP assignment | Query about |
| | | | Extraction of IP | information, | malicious IP |
| | | | based on IP band using | band | of the same |
| | | | query | information | C-Class band |
| | | Registration | tb_ip2location.country_ | IP assignment | Query about |
| | | place | name | country and | geographical |
| | | | (req_ip) | geographical | information |
| | | | | information | difference of |
| | | | | | domain- |
| | | | | | mapping |
| | Domain | Mapping | tb_mapping_domain.domain | Domain | Query about |
| | | domain | | information | directly |
| | | | | using IP | connected |
| | | | | during | domain |
| | | | | analysis | |
| | | | | period | |
| | | Malicious | tb_ctas_spread.domain | URL using IP | Query about |
| | | domain | tb_malcrawler_data.seed_ | to distribute | malicious |
| | | | url | malware | domain having |
| | | | malwares.com needs | | past |
| | | | to be discussed again | | malware |
| | | | | | distribution |
| | | | | | history |
| | Malware | Distribution | tb_cbs_file.hash | Malware file | Query about |
| | | | tb_malwares_ip_dect_down_ | name/Hash | distributed |
| | | | sample.sha256 | distributed | malware |
| | | | | in IP | |
| | | Reverse | tb_malwares_ip_dect_ | Malware file | Query about |
| | | access | comm_sample.sha256 | name/Hash | malware |
| | | | tb_cuckoo_analysis_info. | that has | communicate |
| | | | sha256 | accessed IP | with C&C |
| | BlackList | Passage | tb_ctas_via.date+time | History | Verification |
| | | history | | (date) in | of past |
| | | | | which | malicious |
| | | | | corresponding | activities |
| | | | | IP has been | |
| | | | | misused as | |
| | | | | passage | |
| | | Distribution | tb_ctas_spread.date+time | History | Verification |
| | | history | | (date) in | of past |
| | | | | which | malicious |
| | | | | corresponding | activities |
| | | | | IP has been | |
| | | | | misused as | |
| | | | | distribution | |
| | | | | place | |
| | | Reverse | tb_ctas_inf_ip.date+time | History | Verification |
| | | access | tb_ctas_malpc.date+time | (date) in | of past |
| | | | tb_ctas_atk_ip.date+time | which | malicious |
| | | | tb_dnsbl_ip.download_dt | malware/PC | activities |
| | | | | has been | |
| | | | | connected to | |
| | | | | corresponding | |
| | | | | IP as C&C and | |
| | | | | leak of | |
| | | | | information | |

Table 3 is a mapping table for an analysis base if an input value is a domain.

TABLE 3

| | Analysis base | | Mapped DB table and column | | |
|---|---|---|---|---|---|
| Input | Large | Small | {table name}.{column name} | | |
| type | classification | classification | (column for obtaining IP) | Description | Use |
| Domain | IP | Malicious | tb_ctas_via.ip | Malicious | Query about |
| | | IP | tb_ctas_spread.ip | IP using | only |
| | | | tb_ctas_cnc.ip | domain | malicious IP |
| | | | tb_malwares_hostname_ | during | of |
| | | | report.ip | analysis | associated |
| | | | (wherein | period | IPs |
| | | | dect_down_count/dect_comm_ | | |
| | | | count > 0) | | |
| | | Mapping | tb_mapping_ip.ip | Query about | |
| | | IP | | IP mapped | |
| | | | | to domain | |
| | Domain | Similar | No | Similar | Base for |
| | | domain | Extraction of similar | domain based | similar |
| | | | domain using query | on TLD/SLD | violation |
| | | | | | incident |
| | | | | | query |
| | | E-mail | tb_whois.registrant_email | Registrant | Base for |
| | | | | e-mail who | similar |
| | | | | has | violation |
| | | | | registered | incident |
| | | | | domain | query |
| | | Registration | tb_whois.registrat_address | Address at | Comparison |
| | | place | | which | with IP- |
| | | | | domain has | based |
| | | | | been | geographical |
| | | | | registered | information |
| | Malware | Distribution | tb_cbs_file.hash | Malware | |
| | | | tb_malwares_hostname_dect_ | (Hash) | |
| | | | down_sample.sha256 | distributed | |
| | | | | by domain | |
| | | Reverse | tb_malwares_hostname_dect_ | Malware | |
| | | access | comm_sample.sha256 | (hash) which | |
| | | | tb_cuckoo_analysis_info.sha256 | has | |
| | | | | performed | |
| | | | | C&C | |
| | | | | communication/ | |
| | | | | leak of | |
| | | | | information | |
| | | | | with domain | |
| | BlackList | Passage | tb_ctas_via.date+time | Time when | |
| | | history | | domain is | |
| | | | | used as | |
| | | | | passage | |
| | | Distribution | tb_ctas_spread.date+time | Time when | |
| | | history | | domain is | |
| | | | | used as | |
| | | | | distribution | |
| | | | | place | |
| | | Reverse | tb_ctas_cnc.date+time | Time when | |
| | | access | | domain is | |
| | | history | | used as | |
| | | | | C&C | |
| | | | | communication | |
| | | | | place/the | |
| | | | | leak of | |
| | | | | information | |

Table 4 is a mapping table for an analysis base if an input value is hash.

TABLE 4

| | Analysis base | | Mapped DB table and column | | |
|---|---|---|---|---|---|
| Input | Large | Small | {table name}.{column name} | | |
| type | classification | classification | (column for obtaining IP) | Description | use |
| Hash | IP | Distribution | tb_cbs_file.ip_addr | IP through | |
| | | | tb_malwares_ip_dect_down_ | which hash | |
| | | | sample.ip_idx | has been | |
| | | | | distributed | |
| | | Reverse | tb_malwares_ip_dect_comm_ | IP to | |
| | | access | sample.ip_idx | which hash | |
| | | | | has been | |
| | | | | connected | |
| | Domain | Distribution | tb_malwares_hostname_dect_ | Domain to | |
| | | | down_sample.hostname_idx | which hash | |
| | | | | has been | |
| | | | | distributed | |
| | | Reverse | tb_malwares_hostname_comm_ | Domain to | |
| | | access | down_sample.hostname_idx | which hash | |
| | | | | has been | |
| | | | | connected | |
| | Malware | Child | tb_anubis_process_activity. | Generated | If |
| | | | process_cr_executable | child | generated |
| | | | tb_anubis_file_activity.file_ | file/process | path/file |
| | | | created | | is shared, |
| | | | | | it may be |
| | | | | | estimated |
| | | | | | as same |
| | | | | | attacker |
| | | Name | tb_cbs_file.file_name | File name | Query about |
| | | | tb_mwcrawler_data.file_name | of hash | malware |
| | | | tb_cuckoo_analysis_info. | | sharing |
| | | | filename | | same file |
| | | | tb_anubis_analysis_info..filename | | name |
| | | | | | Accuracy |
| | | | | | is |
| | | | | | different |
| | | | | | depending |
| | | | | | on length |
| | | | | | of test |
| | | | | | string |
| | | Vaccine | tb_malwares_hash_detected. | Vaccine | Query about |
| | | | result | detection | malware |
| | | | Major vaccines need to | name of | classified |
| | | | be selected | hash | as same |
| | | | | | behavior |
| | | Behavior | Not determined | API | Base for |
| | | | | behavior | query about |
| | | | | similar | similar |
| | | | | group | violation |
| | | | | information | incident |
| | | Signatures | No | Similar | Base for |
| | | | Hash query using query | file based | query about |
| | | | (tb_cuckoo_analysis_info. | on YARA | similar |
| | | | yara) | signatures | violation |
| | | | | | incident |

FIG. 6 is a block diagram showing the configuration of the intelligence generation and management module 230 according to an embodiment of the present invention.

As shown in FIG. 6, the intelligence generation and management module 230 according to an embodiment of the present invention is configured to include an intelligence format conversion unit 232, an intelligence generation unit 234, and an intelligence history management unit 236. The intelligence generation and management module 230 generates intelligence based on a policy stored in the violation information intelligence analysis system 200 in response to an intelligence generation request, converts the format of the intelligence in order to transfer the intelligence to the outside, and stores history information.

The intelligence format conversion unit 232 fetches a black box information access controller and converts intelligence analysis results into a format (e.g., XML or JSON) operating in conjunction with a black box. The intelligence format conversion unit 232 supports a JavaScript Object Notation (JSON) format for an operation in conjunction with a GUI and supports an eXtensible Markup Language (XML) format for an operation in conjunction with a black box.

The intelligence generation unit 234 generates intelligence based on analysis results by executing the intelligence analysis module 240.

The intelligence generation unit 234 requests an analysis of intelligence from the intelligence analysis module 240. In this case, the analysis request message includes information about a required intelligence analysis type.

The intelligence generation unit 234 functions as an interface, such as the exchange of collected information for the operations of an N-depth analysis unit 244 and relationship analysis unit 246 which substantially perform intelligence analyses. Furthermore, the intelligence generation unit 234 functions to manage intelligence analyses, such as the first starting point of an intelligence analysis and an intelligence history management request.

Furthermore, the intelligence generation unit 234 sends a specific request message through an API tool in order to send intelligence analysis results converted by the intelligence format conversion unit 232. The intelligence generation unit 234 includes information, such as an analysis request time, an analysis time, and a requester (e.g., a GUI, a user, or a system), in a request message and requests history management from the intelligence history management unit 236.

The intelligence history management unit 236 performs a query about an intelligence analysis request and intelligence analysis results and stores the intelligence analysis request and intelligence analysis results.

The intelligence history management unit 236 functions to perform a query about a history (or an intelligence history) of an intelligence analysis request and analysis results and storing the history.

When an intelligence history is stored, the intelligence history management unit 236 summarizes and stores intelligence analysis results. In this case, stored intelligence history information includes pieces of information, such as an analysis request time, an analysis time, the number of analysis results, a requester (e.g., a GUI, a user, or a system), and contents.

The intelligence history management unit 236 needs to additionally derive information about the number of analysis results and contents through the intelligence history storage function. The contents are divided into “black box intelligence”, an “N-depth analysis”, a “relationship analysis”, and an “integrated analysis” depending on a type in which intelligence is generated. The number of analysis results is set based on the type of black box intelligence.

The intelligence history management unit 236 performs a query about an intelligence analysis history stored through the intelligence history storage function. The intelligence history management unit 236 receives the subject of request and a time range from a user, performs a query about an intelligence analysis history to be checked, and returns a result value.

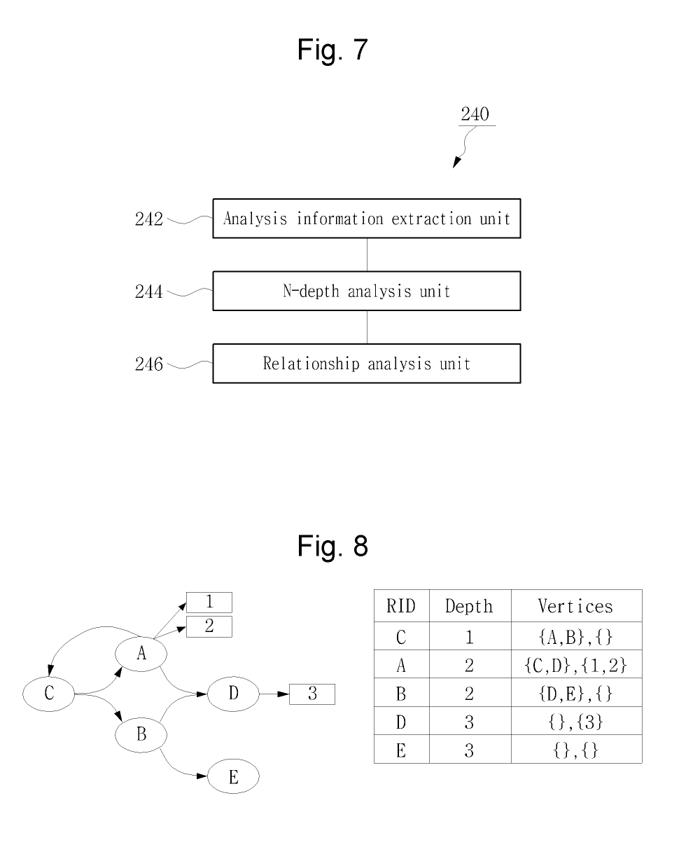

FIG. 7 is a block diagram showing the configuration of the intelligence analysis module 240 according to an embodiment of the present invention.

As shown in FIG. 7, the intelligence analysis module 240 according to an embodiment of the present invention is configured to include an analysis information extraction unit 242, the N-depth analysis unit 244, and the relationship analysis unit 246. The intelligence analysis module 240 supports an in-depth information analysis (i.e., an N-depth analysis) and a relationship analysis using information extracted from the violation information DB 250.

The analysis information extraction unit 242 performs a query about base information required to perform an intelligence analysis and requests the collection of additional information.

The analysis information extraction unit 242 extracts “raw data”, a “relationship”, and “previously generated intelligence analysis information” for a violation information intelligence analysis.

The analysis information extraction unit 242 receives a result type (e.g., raw data, a relationship, and intelligence analysis information), a request information type (e.g., a violation resource (“1”), attribute (“0”), and a request information ID as listed in Table 5.

TABLE 5

| Input value | | Value | Description |
|---|---|---|---|
| Result | Raw data | 1 | Return raw data |
| type (3 | | | information |
| bits) | Relationship | 1 | Return relationship |
| | | | information |
| | Intelligence | 1 | Return intelligence |
| | | | analysis information |

| | | |
|---|---|---|
| Request information | Violation resource: | Type of Inputted request |
| type | 1, attribute: 0 | information ID |
| Request information ID | {ID value} | Violation |
| | | resource/attribute ID |

<Input Value Table of the Analysis Information Extraction Unit 242>

The analysis information extraction unit 242 is executed using the values, listed in Table 5, as input values.

Furthermore, the executed analysis information extraction unit 242 fetches the violation information query function of the violation information management unit 216, collects violation information based on the result type setting value of 3 bits, and returns a collected value (e.g., raw data, a relationship, or intelligence analysis information).

If the result type setting value of 3 bits supports both raw data and a relationship (e.g., 110), the analysis information extraction unit 242 generates the summary table of Table 6. Furthermore, the analysis information extraction unit 242 returns the generated summary table along with the raw data and relationship information.

TABLE 6

| Order | Column | Description |
|---|---|---|
| 1 | no | Order of row |
| 2 | rid | Resource ID |
| | | if tid is resource, rid is ID of From |
| 3 | tid | Attribute ID/Resource ID (To ID) |
| 4 | tid_type | Type of tid (Resource: 1, Attribute: 0) |
| 5 | kind | ID (kind) of table including raw data mapped to |
| | | relationship |
| 6 | seq | Index (seq) of table including raw data mapped to |
| | | relationship |

The N-depth analysis unit 244 constructs an N-depth relationship corresponding to a depth setting value using the analysis information extraction function, maps the -Depth relationship to violation information, and converts the mapping results into data of an intelligence format.

The N-depth analysis unit 244 configures an N-depth information sequence by associating relationships having 1-Depth. Furthermore, the N-depth analysis unit 244 structurally constructs raw data information mapped to relationship information. In order to construct raw data information, the N-depth analysis unit 244 receives a violation resource ID, a depth value (e.g., N), and analysis type information of 2 bits as input values. The N-depth analysis unit 244 receives the depth value (e.g., N) of the input values from a user.

The N-depth analysis unit 244 outputs the analysis results of N-depth, including a relationship violation information graph and raw data, and represents the relationship violation information graph in an adjacency list manner, as shown in FIG. 8. FIG. 8 is a diagram illustrating a data configuration according to an N-depth analysis.

The analysis type information is a combination of 2 bits as listed in Table 7 and may represent a case where only relationship data is received, a case where only raw data is received, and a case where both raw data and relationship data are received.

TABLE 7

| Query request (2 bits) | | |
|---|---|---|
| Raw data | Relationship | Description |
| | 1 | Receive relationship information about N-depth |
| | | analysis results of inputted violation |
| | | resource |
| 1 | | Receive raw data for N-depth analysis results |
| | | of inputted violation resource |

The N-depth analysis unit 244 starts operating when an N-depth analysis is requested by the intelligence generation unit 234 of the intelligence generation and management module 230.

Furthermore, the N-depth analysis unit 244 that has starts its operation executes the analysis information extraction unit 242 and performs a query about association information about the violation resource ID of an input value. In this case, the executed analysis information extraction unit 242 executes the violation information query function of the violation information management unit 216 in RR-From, RA acquisition mode, obtains relationship information, and returns the relationship information.

The N-depth analysis unit 244 stores the obtained relationship information a data form of RID, depth, or vertices as listed in Table 8. Table 8 is a table showing a vertex configuration.

TABLE 8

| RID | Depth | Vertices |
|---|---|---|
| Violation | Depth degree | {(plural) connected RID}, {(plural) |
| resource ID | | connected AID} |

The Vertices are indicated by “{RIDvalue}, {AIDvalue}”, and are simply indicated by { } if the value of RID or AID is null.

If raw data is to be returned, the N-depth analysis unit 244 executes the analysis information extraction unit 242 and receives raw data information of RID shown in Table 8. Furthermore, the N-depth analysis unit 244 returns a result value based on analysis type information of 2 bits of an input value.

The relationship analysis unit 246 selects the subjects of comparison of violation resources for a relationship analysis and performs a comparison and query on pieces of information that are identically or similarly used between the selected subjects of comparison. The relationship analysis unit 246 chiefly performs the extraction of N-depth information and a relationship analysis.

In order to extract the N-depth information, first, the relationship analysis unit 246 fetches the N-depth analysis unit 244 and calculates a relationship violation information tree. Furthermore, the relationship analysis unit 246 extracts only information about the nodes of a tree from the calculated relationship violation information tree and lists the information on the same line.

The relationship analysis unit 246 receives N violation resources and an N-depth number as input values. In this case, the N violation resources are inputted in an array form. The reason why only violation resources of violation information are used as input values is that only the violation resources can operate in an analysis channel.

When the relationship analysis unit 246 starts operating, first, it checks the N violation resources of the input value and fetches the analysis information extraction unit 242.

Thereafter, when the analysis information extraction unit 242 returns a result value, the relationship analysis unit 246 sorts the result value into an “inputted violation resource” and “calculated violation information” and stores them.

The relationship analysis unit 246 repeatedly performs such an operation (e.g., the fetching of the analysis information extraction unit & the sort and storage) by the number of violation resource (N) of the input values.

Furthermore, the relationship analysis unit 246 stores a set of pieces of violation information calculated in the first inputted violation resource regardless of the depth of the repeatedly performed result information. Furthermore, the relationship analysis unit 246 performs a relationship analysis procedure using the calculated violation information as a parameter.

For a relationship analysis, first, the relationship analysis unit 246 receives a plurality of violation resources (e.g., two or more) as parameters.

Furthermore, the relationship analysis unit 246 performs a query about a value that belongs to information calculated in the N-depth information extraction procedure and that is identically used. Furthermore, the relationship analysis unit 246 separately configures items (e.g., a group (1.2.3.4&test.co.kr)) that belong to the pieces of calculated N-depth information and that correspond to an intersection of an IP, a domain, and hash.

For example, if N-depth information calculated for IP (1.2.3.4) is a, b, and c in the N-depth information extraction procedure and N-depth information calculated for a domain (test.co.kr) is b, c, and d, an IP (1.2.3.4) has a result value of “a”, a domain (test.co.kr) has a result value of “d”, and a group (1.2.3.4 & test.co.kr) has a result value of “b” and “c.” In the example, only the IP and the domain have been illustrated, for convenience of description, but N-depth information calculated for hash may also be added.

Thereafter, the relationship analysis unit 246 returns the result value of the N-depth information extraction procedure and terminates its operation.

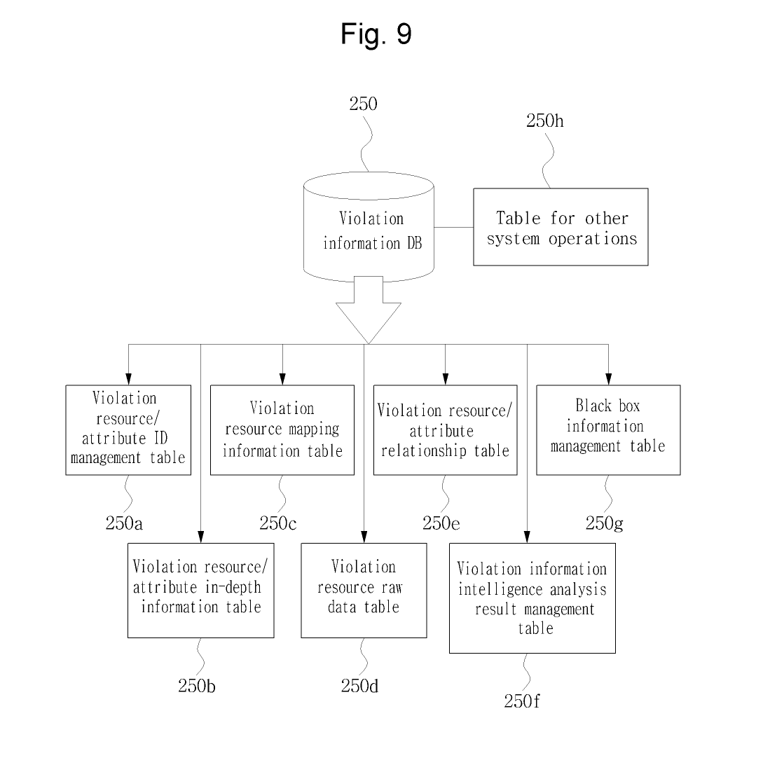

FIG. 9 is a block diagram showing the configuration of the violation information DB 250 according to an embodiment of the present invention.

As shown in FIG. 9, the violation information DB 250 according to an embodiment of the present invention includes 8 storage regions (or tables).

The violation information DB 250 according to an embodiment of the present invention is configured to include a violation resource/attribute ID management table 250a, a violation resource/attribute in-depth information table 250b, a violation resource mapping information table 250c, a violation resource raw data table 250d, a violation resource/attribute relationship table 250e, a violation information intelligence analysis result management table 250f, a black box information management table 250g, and a table 250h for other system operations.

In the case of the violation resource raw data table 250d, the violation information DB 250 defines raw data based on a collection/query channel table defined in the violation incident association information collection system 100 and adds columns to the violation resource raw data table 250d, if necessary.

In the case of violation information for managing IDs, such as violation resources (e.g., an IP, a domain, and hash) or attributes (e.g., e-mail, geographical information, and a similarity group), the violation information DB 250 converts raw data into an ID and stores the ID. For example, if raw data including an IP (1.2.3.4) is collected, the violation information DB 250 issues the ID of 1.2.3.4 (if there is no previously stored information), replaces 1.2.3.4 with the issued ID 100, and stores the ID 100.

The violation information intelligence analysis system according to an embodiment of the present invention may be implemented in a computer-readable recording medium using software, hardware, or a combination of them.

According to a hardware implementation, the violation information intelligence analysis system described herein may be implemented using at least one of application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and other electrical units for executing functions. In some cases, the embodiments described in this specification may be implemented using the violation information intelligence analysis system itself.

As described above, the embodiments of the present invention have proposed a detailed configuration and scheme for designing the AEGIS of the integrated security situation analysis system including the collection system and the analysis system, in particular, a detailed configuration and design scheme regarding an analysis system (e.g., a violation information intelligence analysis system) of the AEGIS.

In accordance with the embodiments of the present invention, it is expected that cloud-based large-scale malware analyses, mobile violation incident analyses and handling, violation incident profiling and attack prediction, and violation incident information sharing through the analysis system (e.g., the violation information intelligence analysis system) of the AEGIS.

Although the present invention has been described with reference to the embodiments shown in the drawings, the embodiments are only illustrative. Those skilled in the art to which the present invention pertains may understand that various other modifications are possible and some or all of the embodiment(s) may be selectively combined. Accordingly, the true technical scope of the present invention should be determined by the technical spirit of the following claims.

What is claimed is:

1. A violation information intelligence analysis system configuring an accumulated and integrated intelligence system (AEGIS) along with a violation incident association information collection system, comprising:
a violation information management module configured to manage information and violation information intelligence analysis-related information received from the violation incident association information collection system;
a collection information analysis module configured to extract a violation information ID based on the received information and to extract a relationship between the violation information ID and raw data;
an intelligence generation and management module configured to generate intelligence based on a policy stored in the violation information intelligence analysis system in response to an intelligence generation request, convert a format of the intelligence in order to externally transfer the intelligence, and store history information; and
an intelligence analysis module configured to support an in-depth information (N-depth) analysis and a relationship analysis using information extracted from a violation information DB.

2. The violation information intelligence analysis system of claim 1, wherein the violation information management module is configured to comprise:
a violation incident association information collection unit configured to analyze the information received from the violation incident association information collection system and log the analyzed information;
a violation information ID management unit configured to query the violation information DB about an ID of violation information and issue an ID to violation information to which a query result ID has not been assigned; and
a violation information management unit configured to query the violation information DB about the raw data or relationship information or store the raw data or the relationship information in the violation information DB and to query the violation information DB about information derived based on an analysis base defined by the violation information intelligence analysis system or an administrator.

3. The violation information intelligence analysis system of claim 1, wherein the collection information analysis module is configured to comprise:
an RA extraction unit configured to extract information which include a violation resource or attributes and which is managed as a violation information ID from information received from the violation incident association information collection system, obtain a violation information ID from the violation information ID management unit, and replace the extracted information with the obtained violation information ID;
a raw data management unit configured to analyze violation information processed using a violation information ID extraction function and to convert the analyzed violation information into a form managed in the violation information DB; and
a relationship management unit configured to analyze a relationship between the violation resources and a relationship between the violation resource and the attribute information based on raw data received from the violation incident association information collection system and to convert the analyzed relationships into a form managed in the violation information DB.

4. The violation information intelligence analysis system of claim 1, wherein the intelligence generation and management module is configured to comprise:
a intelligence format conversion unit configured to fetch a black box information access controller and to convert intelligence analysis results into a format for an operation in conjunction with a black box;
an intelligence generation unit configured to generate intelligence based on results analyzed by executing the intelligence analysis module; and
an intelligence history management unit configured to perform a query on an analysis request for the intelligence and analysis results of the intelligence and store the analysis request for the intelligence and the analysis results of the intelligence.

5. The violation information intelligence analysis system of claim 1, wherein the intelligence analysis module is configured to comprise:
an analysis information extraction unit configured to perform a query on base information for an intelligence analysis and request a collection of additional information;
an N-depth analysis unit configured to construct an N-depth relationship corresponding to a depth setting value using an analysis information extraction function, map the constructed N-depth relationship to the violation information, and convert results of the mapping into data of an intelligence format; and
a relationship analysis unit configured to select subjects of comparison of violation resources for a relationship analysis and perform a comparison and query on pieces of identically or similarly used information between the selected subjects of comparison.

6. The violation information intelligence analysis system of claim 1, wherein the violation information comprises violation resource information and attribute information.
